(19) United States
(12) Patent Application Publication
(10) Pub. No.: US 2016/0332378 A1
(43) Pub. Date: Nov. 17, 2016

(54) THREE DIMENSIONAL (3D) DELTA PRINTER FRAME STRUCTURE

(71) Applicant: Autodesk, Inc., San Rafael, CA (US)

(72) Inventors: James Sherwood Page, Berkeley, CA (US); Cory Mark Bloome, San Francisco, CA (US); Kenneth Lawrence Mejia, San Francisco, CA (US)

(21) Appl. No.: 15/222,672

(22) Filed: Jul. 28, 2016

Related U.S. Application Data
(60) Provisional application No. 62/288,246, filed on Jan. 28, 2016.

(51) Int. Cl. B29C 67/00; B33Y 40/00; B33Y 50/02; B33Y 30/00

(52) U.S. Cl. CPC B29C 67/0085; B33Y 30/00; B33Y 40/00; B29C 67/0055; B33Y 50/02

(57) ABSTRACT

Systems and techniques relating to three dimensional (3D) delta printers, such as Fused Filament Fabrication (FFF) 3D delta printers include, in at least one aspect, a 3D delta printer that includes a build platform; a 3D printer delta motion system; and a space frame configured and arranged to support the 3D printer delta motion system as the 3D printer delta motion system moves relative to the build platform; wherein the space frame includes multiple triangular units surrounding a build volume above the build platform.

### CROSS-REFERENCE TO RELATED APPLICATIONS

This application claims the benefit under 35 U.S.C. §119(e) of U.S. Patent Application No. 62/288,246, entitled “THREE DIMENSIONAL (3D) DELTA PRINTER FRAME STRUCTURE”, filed Jan. 28, 2016; this application is related to U.S. Patent Application No. 62/288,262, titled “THREE DIMENSIONAL (3D) PINTER MOTION SYSTEM”, filed on Jan. 28, 2016, under Attorney Docket No. 15786-0257P01; and both of these prior applications are hereby incorporated by reference.

### BACKGROUND

This specification relates to components of three dimensional (3D) printers, such as Fused Filament Fabrication (FFF) 3D printers.

3D printers employ additive manufacturing techniques, where a product can be built by the addition of materials. Various types of additive manufacturing techniques can be employed, including granular techniques (e.g., Selective Laser Sintering (SLS) and Direct Metal Laser Sintering (DMLS)) and extrusion techniques (e.g., FFF). In addition, various types of 3D printer structures are employed for 3D printing. For example, FFF 3D printers include both Cartesian (xyz) type 3D printers and delta type 3D printers. In typical Cartesian (xyz) type 3D printers, a carriage for a hot end for an extruder, and/or a build platform, is connected with rails that extend in the three orthogonal dimensions of printing (x, y & z). In contrast, in typical delta type 3D printers, a carriage for a hot end for an extruder is connected by arms with three rails that extend in only the z direction, and the carriage is moved in three dimensions by independently adjusting the positions of end points of the arms along the three rails.

### SUMMARY

This specification describes systems and techniques relating to 3D delta printers, such as FFF 3D delta printers. In general, one or more aspects of the subject matter described in this specification can be embodied in a 3D delta printer that includes: a build platform; a 3D printer delta motion system; and a space frame configured and arranged to support the 3D printer delta motion system as the 3D printer delta motion system moves relative to the build platform; wherein the space frame includes multiple triangular units surrounding a build volume above the build platform.

The 3D printer delta motion system can include three drive units located in three respective sections of the space frame, and each of the three respective sections of the space frame can include three triangular facets forming angles with respect to the build platform that are greater than ninety degrees. The multiple triangular units of the space frame can form eight triangular facets. The multiple triangular units of the space frame can form fourteen triangular facets. Other numbers of facets are also possible. In addition, a top center facet of the triangular facets can be parallel with a plate on a top center position of the space frame over the build volume.

The multiple triangular units can include beams connected at nodes. The 3D delta printer can include a triangular plate on a top center position of the space frame over the build volume, and the triangular plate can have truncated corners and/or include perforations. The beams can include tubes. The nodes can include welded junctions for the beams. The nodes can include fastened junctions for the beams. The nodes can include 3D printed junctions for the beams. Moreover, the multiple triangular units can include metal bent to specific angles.

Particular embodiments of the subject matter described in this specification can be implemented to realize one or more of the following advantages. Using a space truss frame structure for a 3D delta printer can reduce both flex and resonance during 3D printing. Further, the frame geometry can be designed to reduce susceptibility to torsion, as well as to reduce or eliminate the use of long vertical structural members in which frame loading can occur mid-member, at the weakest point of the member. A space truss type frame can be used, where the structural stiffness is derived from triangular frame geometries. The systems and techniques described herein can result in reduced frame distortion, which can likewise result in fewer 3D print distortions. 3D printer performance can thus be improved, including facilitating the creation of more accurate 3D prints. Moreover, in some cases, equally accurate 3D prints can be realized at higher accelerations since acceleration of the carriage imparts force on the frame, and it can take greater force to distort the truss frame the same amount as a non-truss frame.

In addition, using a circular perimeter drive structure for a 3D printer motion system can increase control and stability, and thus reduce vibrations and distortions. A circular perimeter drive structure can be used with a Stewart platform, a 3D printer delta motion system, or both. In the context of a 3D delta printer, the use of a circular perimeter drive assembly to move the carriage can eliminate the need to use long lengths of unsupported belts or cables, which can thus increase accuracy and precision of the movement of the carriage by eliminating long lengths of unsupported belts or cables that tend to resonate (like strings on a musical instrument). This can result in fewer 3D print distortions, and 3D printer performance can thus be improved, including facilitating the creation of more accurate 3D prints and higher speed 3D prints. The circular perimeter drive puts the mass of the motor and any pulleys on the frame, off the sector, and lower mass on the sector translates into less force needed for acceleration and consequently less distortion on affected components in the system and less demand on motors (e.g., potentially can use smaller, less expensive motors to accelerate a smaller mass at a given rate).

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1A is a perspective view of an example of a delta type 3D FFF printer in accordance with some implementations.

FIG. 1B is a block diagram showing an example of a 3D printer delta motion system.

FIGS. 1C-1J are various views of the frame structure for the delta type 3D FFF printer of FIG. 1A.

FIGS. 2A-2C show other examples of frame structures for delta type 3D FFF printers.

FIGS. 3A-3E show examples of a sector shaped portion of a circular perimeter drive assembly.

FIGS. 4A-4M show another example of a circular perimeter drive assembly.

FIGS. 5A & 5B show examples of using a circular perimeter drive assembly with a Stewart platform.

Like reference numbers and designations in the various drawings indicate like elements.

### DETAILED DESCRIPTION

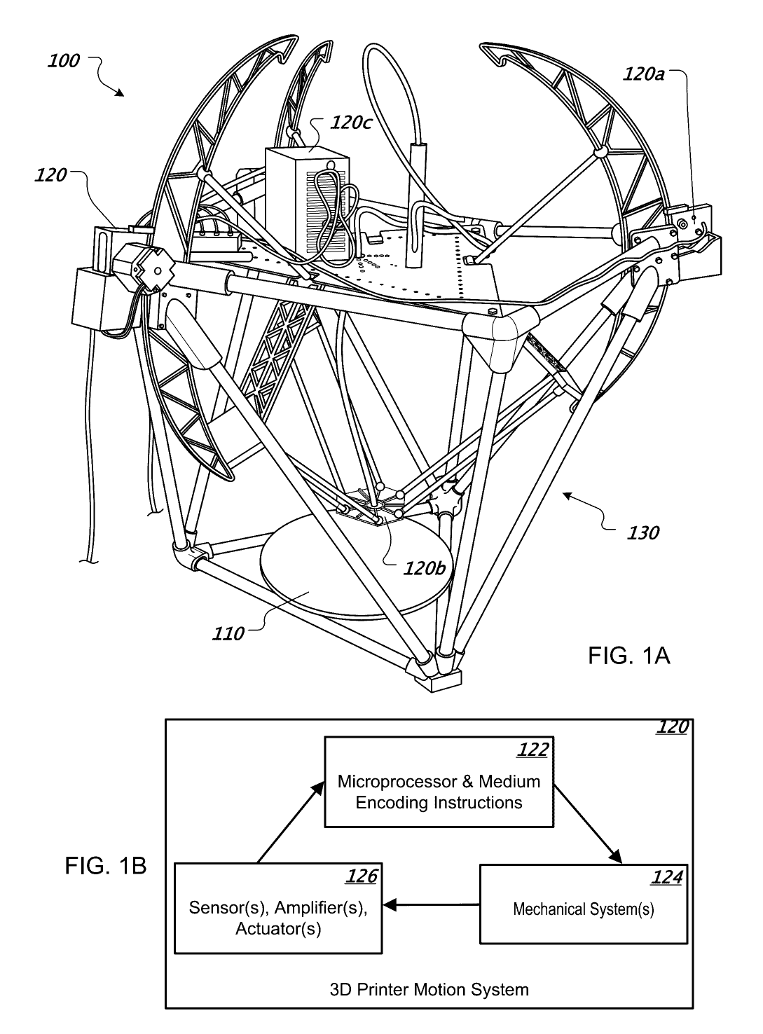

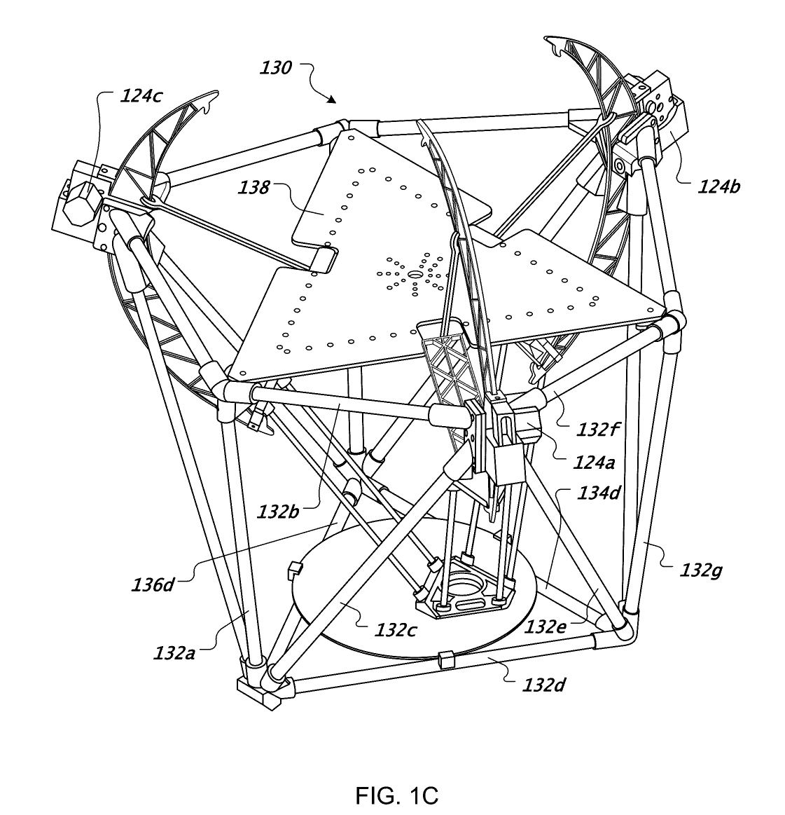

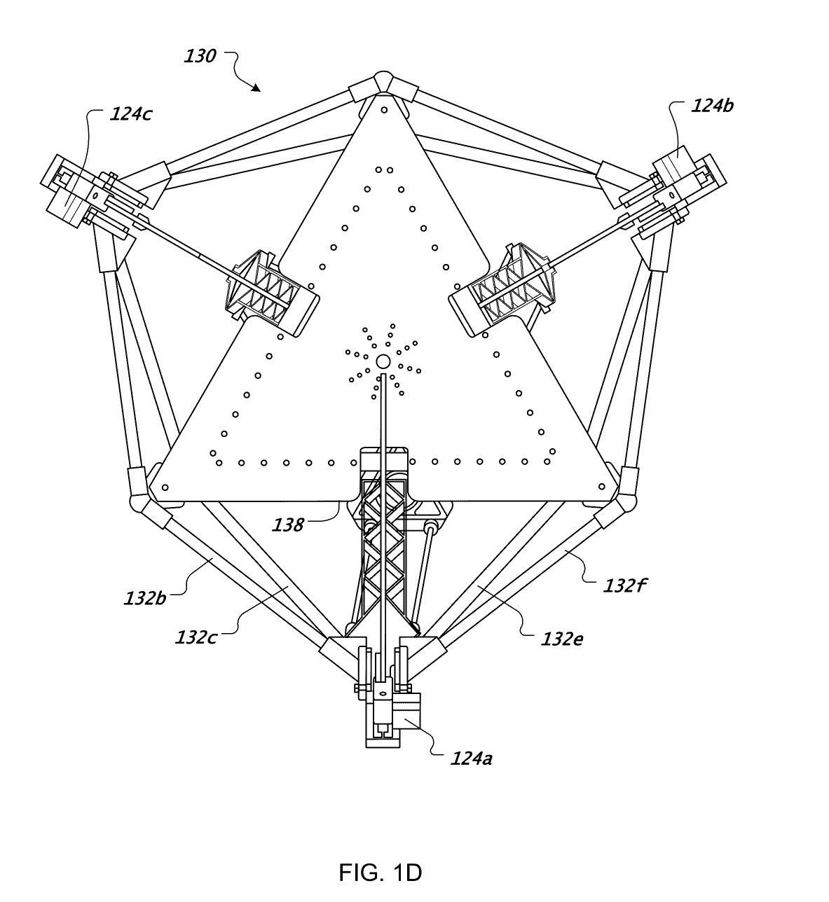

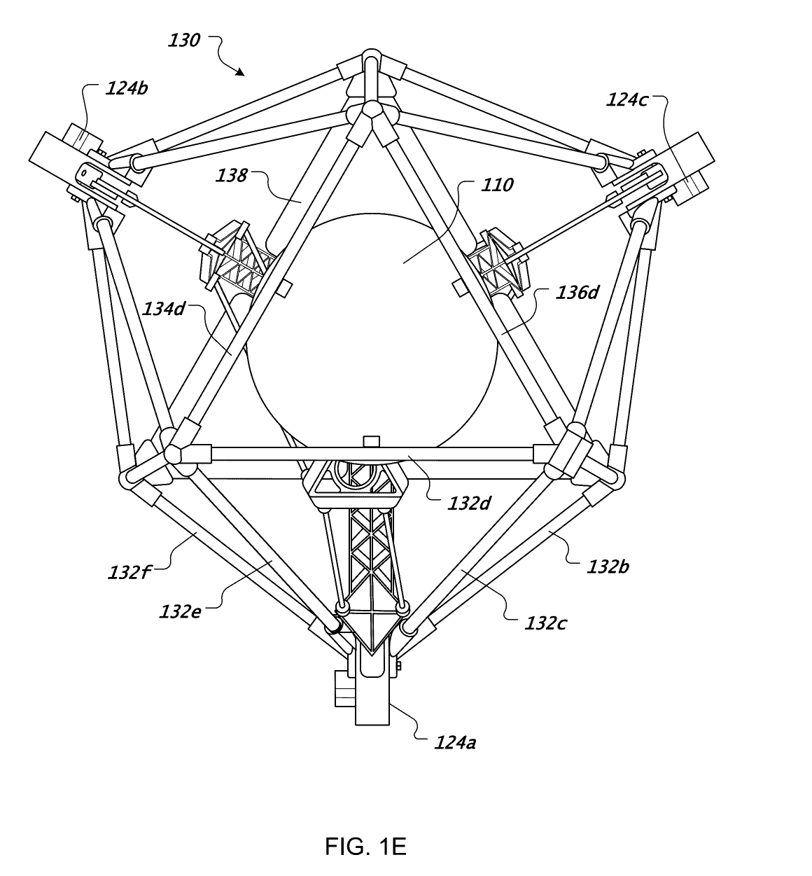

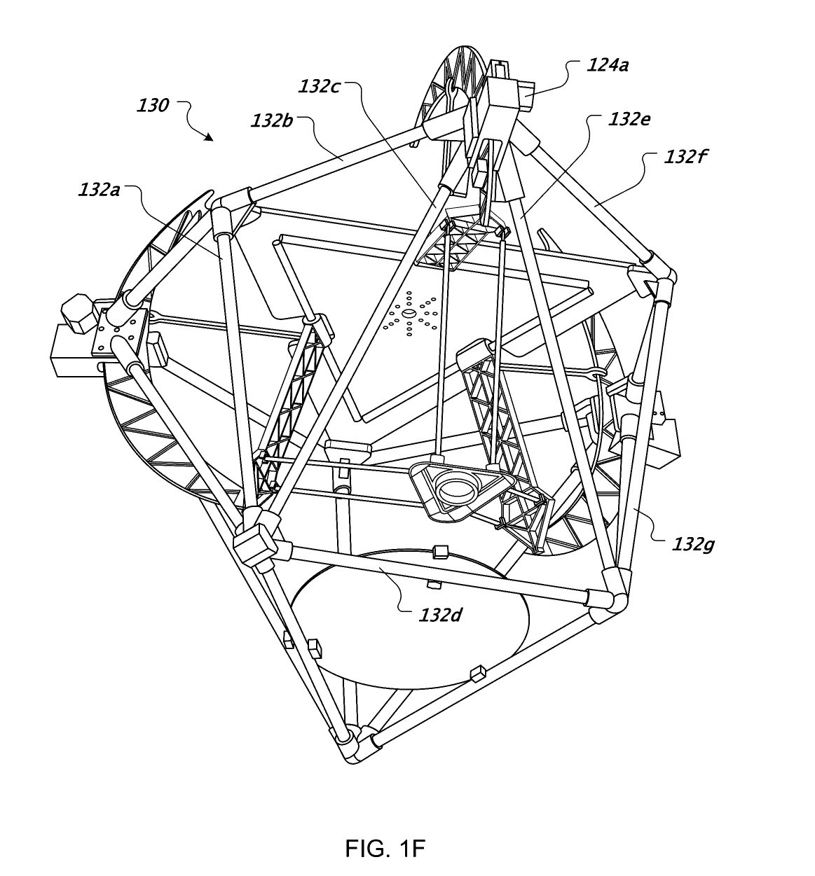

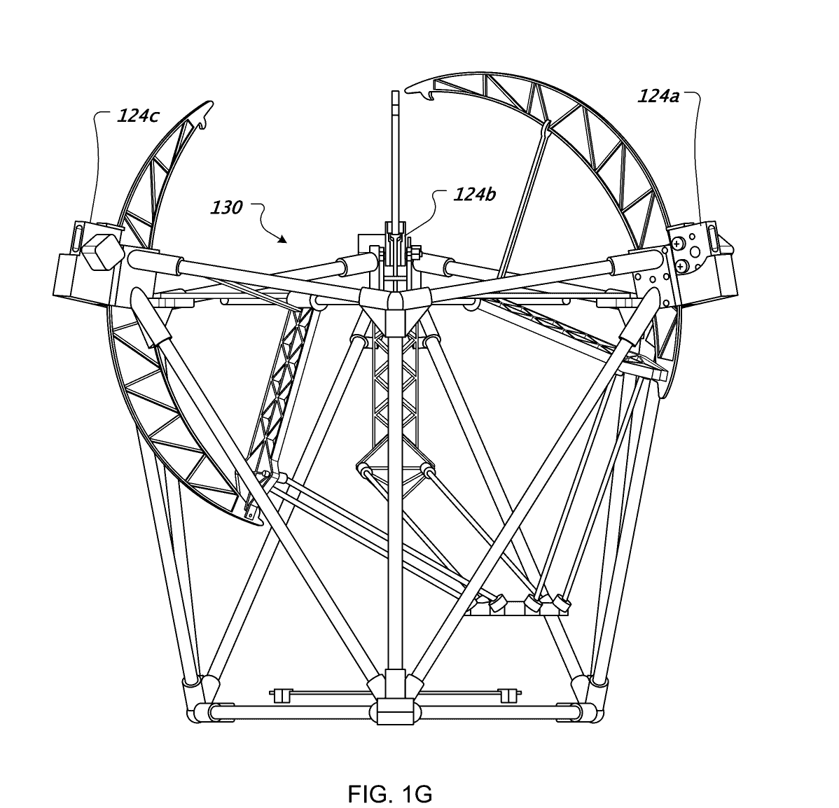

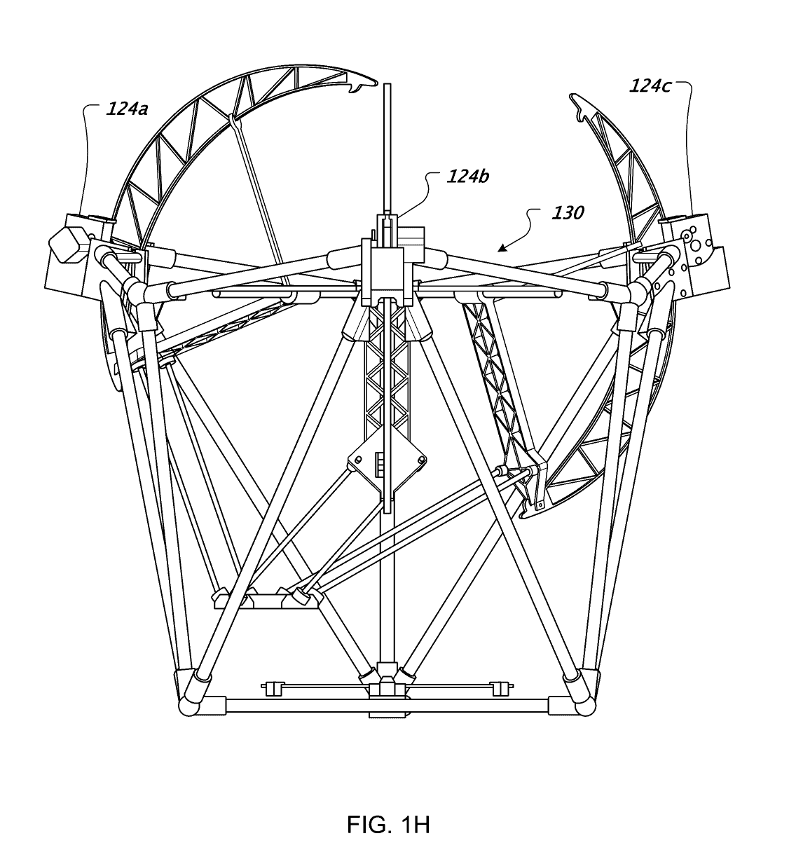

FIG. 1A is a perspective view of an example of a delta type 3D FFF printer 100 in accordance with some implementations. The 3D delta printer 100 includes a build platform 110 and a 3D printer delta motion system 120. The build platform 110 can be a single build plate, or the build platform 110 can include more than one build plate and one or more other structures, such as a heater for the build plate(s). In some implementations, the build platform 110 can employ the systems and techniques described in U.S. Patent Application No. 62/275,706, titled “CONTROLLABLE RELEASE BUILD PLATE FOR 3D PRINTER”, filed on Jan. 6, 2016, under Attorney Docket No. 15786-0267P01, which application is hereby incorporated by reference.

In addition, the 3D printer delta motion system 120 can include various types of mechanical drive systems (e.g., a circular perimeter drive motor 120a) for causing delta printing movement of a carriage (e.g., a carriage 120b), as well as various types of processor electronics (e.g., a control computer 120c) that have been designed and/or programmed to control the mechanical systems to cause the delta 3D printing. Further, the 3D printer delta motion system 120 can also include various sensors and other components. FIG. 1B is a block diagram showing an example of a 3D printer delta motion system 120.

In some implementations, the 3D printer delta motion system 120 includes at least one processor and medium encoding instructions 122 (e.g., a microprocessor with embedded firmware), one or more mechanical systems 124 (e.g., to physically move the carriage, the build platform, or both), and one or more sensor(s), amplifier(s), and actuator(s) 126. Thus, the 3D printer delta motion system 120 can be a mechatronic system, which monitors the build environment and/or the 3D printer using sensors, and processes the sensor information in order to change the behavior of the system so as to react to changes in the build environment and/or the 3D delta printer itself. In this case, the encoded instructions (e.g., software) has become an integral element of the 3D printer, allowing the 3D printer to identify and react to situational changes that can occur during 3D printing.

In some implementations, the 3D printer motion system 120 includes one or more portions of the extruder. For example, the system 120 can include the extrusion motor, filament drive mechanism, or both. In some implementations, the system 120 can include extruder drives that employ the systems and techniques described in U.S. Patent Application No. 62/287,352, titled “EXTRUDER DRIVE MECHANISM FOR THREE DIMENSIONAL (3D) PRINTER”, filed on Jan. 26, 2016, under Attorney Docket No. 15786-0262P01, which application is hereby incorporated by reference. Furthermore, in some implementations, the carriage can hold and transport a hot end that employs the systems and techniques described in U.S. Patent Application No. 62/217,606, titled “NARROW ANGLE HOT END FOR THREE DIMENSIONAL (3D) PRINTER”, filed on Sep. 11, 2015, under Attorney Docket No. 15786-0265P01, which application is hereby incorporated by reference.

Referring again to FIG. 1A, the 3D delta printer 100 also includes a space frame 130. The space frame 130 is configured and arranged (e.g., as shown in FIG. 1A) to support the 3D printer delta motion system 120 as it moves relative to the build platform 110. This movement causes the carriage 120b to move within the build volume above the build platform 110. In addition, the space frame 130 is composed of multiple triangular units (e.g., as shown in FIG. 1A) surrounding this build volume. Note that in some implementations (e.g., as shown in FIG. 1A) the space frame 130 extends below and also supports the build platform 110.

Using such non-traditional structural frame geometries with a delta-type 3D printer can provide significant improvements for 3D printing. Using a triangle based space truss frame geometry means that straight structural members are joined to form a rigid structure with triangular units connected at nodes. This type of structure can reduce or minimize distortion in the 3D printer frame during 3D printing, such as torsion, flex, and resonance caused by the mechanical forces on the frame during printing. Note that the triangular units are not perfect triangles; the corners can be rounded or otherwise truncated, and the edges can be modified while still maintaining the generally triangular nature. In addition, the triangular units can have other modifications made thereto, including use of solid pieces (e.g., triangular plates) which can include one or more holes (e.g., perforations) and potentially additional components.

FIG. 1C is a top perspective view of the frame structure 130 for the delta type 3D FFF printer of FIG. 1A. The frame structure 130 supports three drive units 124a, 124b, 124c of the 3D printer delta motion system, where each of these three drive units 124a, 124b, 124c is located in a respective region of the frame 130. Each of these three respective regions of the space frame 130 can include two or more facets of the space frame 130. In the example shown, each of the respective regions of the space frame 130 has four triangular facets, which when added to the top and bottom facets, makes a total of fourteen facets. Other implementations have different numbers of facets (e.g., eight facets).

The bottom facet in this example is composed of the three base beams 132d, 134d, 136d, which are connected together at their ends. In the example shown, each beam of the space frame 130 is a tube that is inserted into tubular receiving members of a junction device. However, other types of beams can be used, including solid beams, I beams, or others. Also, various types of materials can be used to construct the beams, including plastic, metal, or composite materials.

In addition, rather than using beams to form the facets, in some implementations, one or more or all of the facets can be created from plates, rather than from beams that are connected together. Moreover, in some implementations, one or more or all of the facets can be made from connected beams that also have a triangular plate attached thereto. For example, in FIG. 1C, a triangular plate 138 is attached on top of the three beams forming the top center facet.

As noted above, each of the respective regions of the space frame 130 has four triangular facets in this example. A drive unit 124a is supported directly by four beams 132b, 132c, 132e, 132f of the space frame. A first facet of the space frame 130 for the drive unit 124a is that formed by the base beam 132d and the two beams 132c, 132e. A second facet of the space frame 130 for the drive unit 124a is that formed by the three beams 132c, 132a, 132b. A third facet of the space frame 130 for the drive unit 124a is that formed by the three beams 132e, 132g, 132f. As shown, each of these first three triangular facets forms an angle with respect to the build platform that is greater than ninety degrees.

FIG. 1D is a top view of the frame structure 130 for the delta type 3D FFF printer. This view shows these same three facets for the section of the 3D printer used for the drive unit 124a ; note that each of these facets forms an angle that is greater than ninety degrees with respect to the build platform (not shown in FIG. 1D) in its horizontal position (which is parallel with the plane of the page in FIG. 1D). This structure allows the frame 130 to expand around the build volume, providing extra room for use of circular perimeter drive mechanisms, a larger build volume, or both. Also, as shown in FIG. 1D, a fourth facet of the space frame 130 for the drive unit 124a is that formed by the two beams 132b, 132f and the proximate side of the plate 138 (or the beam to which it attaches).

FIG. 1E is a bottom view of the frame structure 130 for the delta type 3D FFF printer. In this view, all fourteen facets can be seen: a top facet formed by the plate 138, a bottom facet formed by the base beams 132d, 134d, 136d, which support the build platform 110 in this example, and the four facets formed by the support structures for each of the three drive units 124a, 124b, 124c. FIG. 1F is a bottom perspective view of the frame structure 130 for the delta type 3D FFF printer. FIG. 1G is a front side view of the frame structure 130 for the delta type 3D FFF printer. FIG. 1H is a back side view of the frame structure 130 for the delta type 3D FFF printer. FIG. 1I is a left side view of the frame structure 130 for the delta type 3D FFF printer. FIG. 1J is a right side view of the frame structure 130 for the delta type 3D FFF printer.

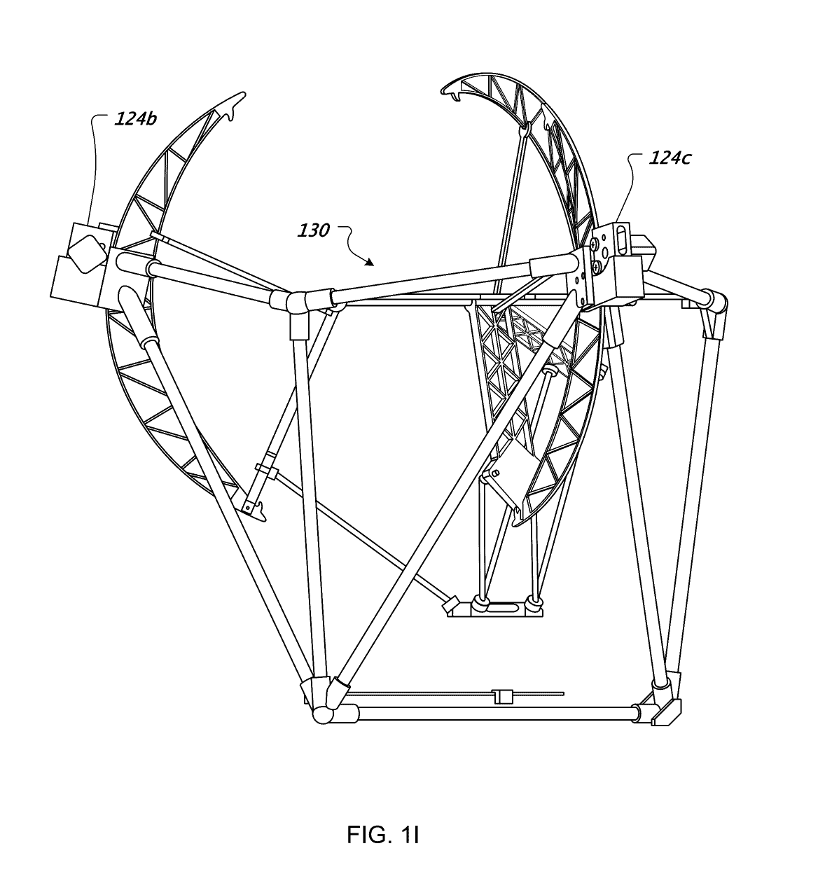

As noted above, variations in the design of the space truss frame for a delta-type 3D printer are also contemplated. FIGS. 2A-2C show other examples of frame structures for delta type 3D FFF printers. These examples have eight facets each, but other numbers of triangular facets are also possible. FIG. 2A shows a space frame 200 for use with a delta 3D printer, where the space frame 200 includes rods or tubes 202, which can be welded to drive unit carriers, e.g., at a first junction 204a, and which can be welded to each other, e.g., at a second junction 204b.

Rather than welding, other connection techniques can be used at the junctions or elbows of the space frame, such as bolts, screws, fasteners, friction, glue or other known mechanical couplings. Further, jigs can be used to hold parts at specific angles, with or without welding (e.g., as shown in FIG. 1A). FIG. 2B shows a space frame 220 in which beams 222 (e.g., metal tubes) are fastened to sheet metal at a first junction 224a and at a second junction 224b. Moreover, in some implementations, the beams themselves can be constructed from sheet metal. FIG. 2C shows a space frame 240 in which a beam 242 is constructed by bending sheet metal to specific angles. Note that a single piece of metal can be used to create more than one beam, as shown in FIG. 2C. Also, sheet metal can be bent at specific angles to create entire facets of the space frame, e.g., multiple facets of the space frame can be created from a single piece of material.

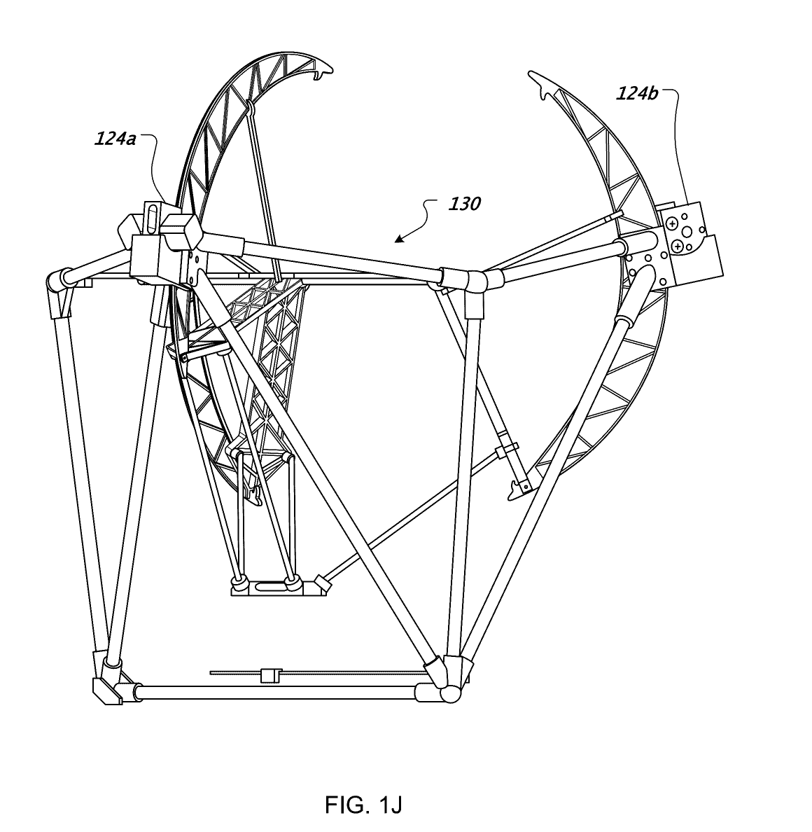

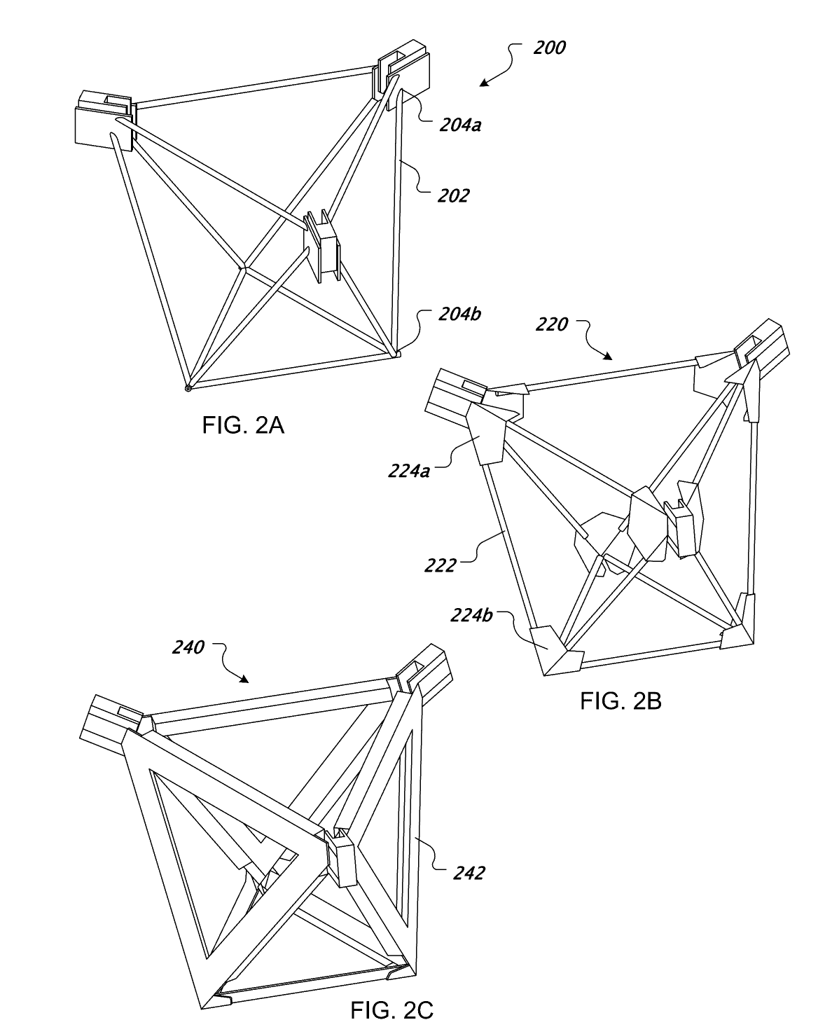

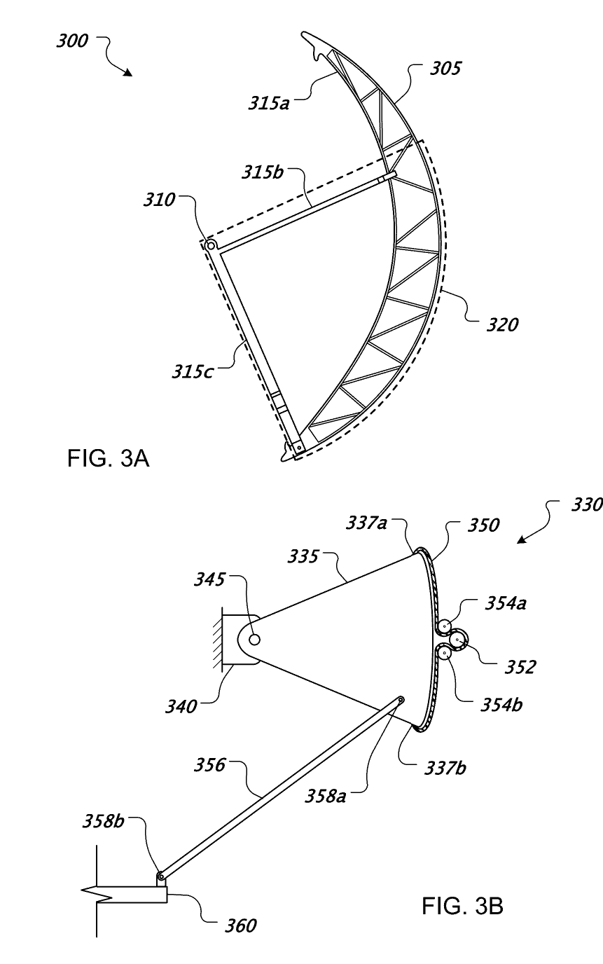

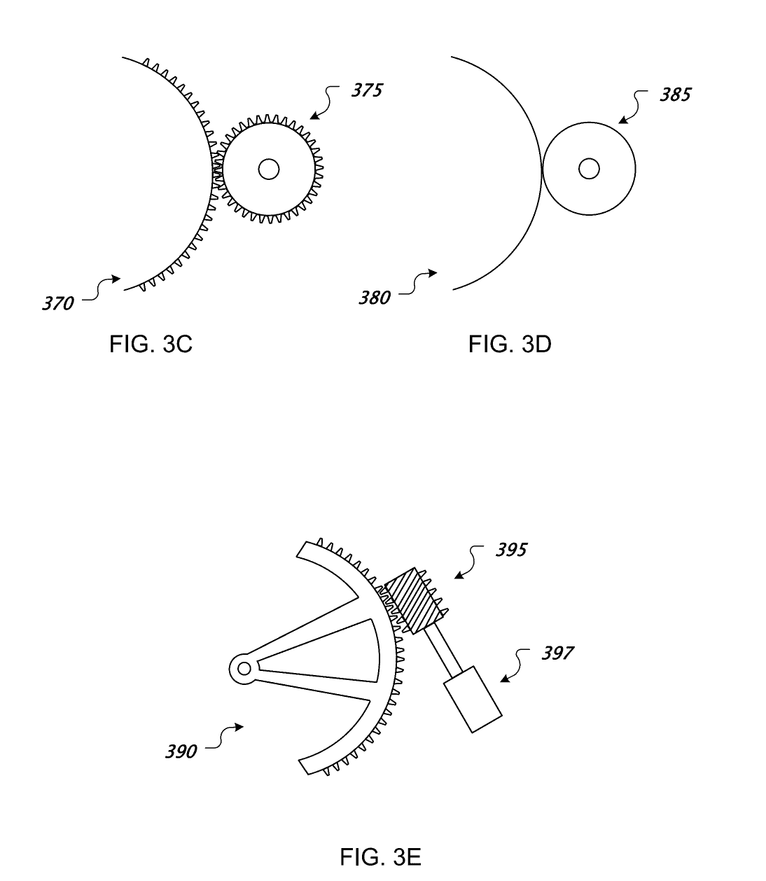

Furthermore, as noted above, circular perimeter drive structures and mechanisms can be used. FIG. 3A shows an example of a sector shaped portion 300 of a circular perimeter drive assembly. This example is taken from the delta type 3D FFF printer shown in FIG. 1J, but the frame structure 130 and the rest of the 3D printer has been removed in FIG. 3A. In addition, the motor 124b that is associated with this section of the circular perimeter drive assembly has also been removed in FIG. 3A to facilitate illustration of the features of the sector shaped portion 300 of the circular perimeter drive assembly.

The portion 300 of the circular perimeter drive assembly includes an arc side 305 and a circle-center side 310. The portion 300 of the circular perimeter drive assembly is sector shaped in that the arc side 305 and the circle-center side 310 correspond to a sector 320. A sector is a plane figure bounded by two radii and the included arc of a circle. As will be appreciated, many variations are possible in the portion 300 of the circular perimeter drive while still retaining it sector shaped character. For example, the arc side 305 can extend beyond the sector 320 (as shown) rather than being coextensive with it (e.g., the arc side 305 can extend for one hundred and twenty degrees of arc while the sector 320 extends for only ninety degrees of arc). As another example, the sector shaped portion 300 of the circular perimeter drive assembly can be a single solid piece, or it can be constructed from separate parts that leave some of the sector 320 void of structural material. Further variations are also possible, including implementations in which the arc side extends for ninety degrees of arc or sixty degrees of arc.

In FIG. 3A, the portion 300 includes a crescent shaped crosspiece 315a attached to struts 315b, 315c. The structural components 315a, 315b, 315c can be constructed as a rigid single piece similar to a bike frame, and the structural components 315a, 315b, 315c can include trusses to increase strength with minimal extra weight for the crosspiece and struts. Nonetheless, it should be noted that the particular crescent shape of the crosspiece 315a and the particular trusses used in the crosspiece 315a and the strut 315c are only one example of many that are possible, and these shapes and trusses can be changed to affect different design aesthetics while still satisfying the mechanical requirements of a given implementation. In any case, the arc side 305 is engaged by a motor that is coupled with the frame, and the circle-center side 310 is attached to the frame at a pivot, such as shown in FIG. 1J.

FIG. 3B shows another example of a circular perimeter drive assembly 330. In this example, portions of an example of a motor assembly and a 3D printer are also shown. The circular perimeter drive assembly 330 includes a solid sector shaped body 335, which is rigidly mounted to a frame 340 at a pivot 345. The circular perimeter drive assembly 330 also includes a motor (not shown) and a drive gear (or wheel) 352, which is attached to the motor and the frame. The drive gear 352 is used to engage the motor with the arc side of the sector shaped body 335, opposite the circle-center side, to drive the sector shaped body 335 about the pivot 345. The drive gear 352 can directly contact the arc side of the sector shaped body 335, or the drive gear 352 can be coupled with the arc side of the sector shaped body 335 indirectly.

In the example shown, the coupling is indirect in that the coupling between the drive gear 352 and the arc side of the sector shaped body 335 is made through a belt 350 that wraps around idlers 354a, 354b. The idlers 354a, 354b are attached to the frame, and the belt 350 is attached to the sector shaped body 335 at a first point 337a and at a second point 337b; note that the points 337a, 337b can be on the non-arc side (as shown) or the arc side of the body 335. The sector shaped body 335 is also attached to a rigid body (e.g., an arm) 356 at a first universal joint 358a, and this rigid body 356 is attached to a carriage 360 of a 3D printer at a second universal joint 358b. Thus, the movement of the sector shaped body 335 about the pivot 345 causes the carriage 360 to move. Moreover, as shown in the previous figures, when the circular perimeter drive assembly includes three such structures in a 3D delta printer, movement of the carriage 360 in three dimensions is readily controllable by the independent movement of the three respective sector shaped bodies about their respective pivots on the frame.

As will be appreciated, various different structures and configurations can be used to engage each motor with its associated sector shaped body. In some implementations, a chain 350 is used rather than a belt 350. Various numbers of gears, chains, teeth, etc. can be employed. FIG. 3C shows an example in which an arc side 370 of a sector shaped portion of a circular perimeter drive assembly includes teeth that mesh with additional teeth on a drive gear 375 of a motor. FIG. 3D shows another example in which an arc side 380 of a sector shaped portion of a circular perimeter drive assembly engages directly with a drive wheel 385 using friction. Each of the arc side 380 and the exterior surface of the drive wheel 385 can be made of one or more materials (e.g., rubber) that provide a coefficient of static friction greater than 0.5, or in some implementations, a coefficient of static friction greater than 1. In some implementations, a belt 350, idlers 354a, 354b, and a drive wheel 352 (see FIG. 3B) are also made one or more of such materials.

FIG. 3E shows another example in which an arc side of a sector shaped body 390 engages directly with a worm gear 395, which is coupled with a motor 397 that is rigidly affixed to the frame (not shown). Rotation of worm gear 395 imparts sector rotation about the pivot point for the body 390. This is similar to a rack & pinion structure. Note also that while the teeth shown in FIGS. 3C and 3E are placed directly on the arc side, other implementations can place the teeth in different locations, such as on an inner edge of the arc or in a pocket adjacent to the arc.

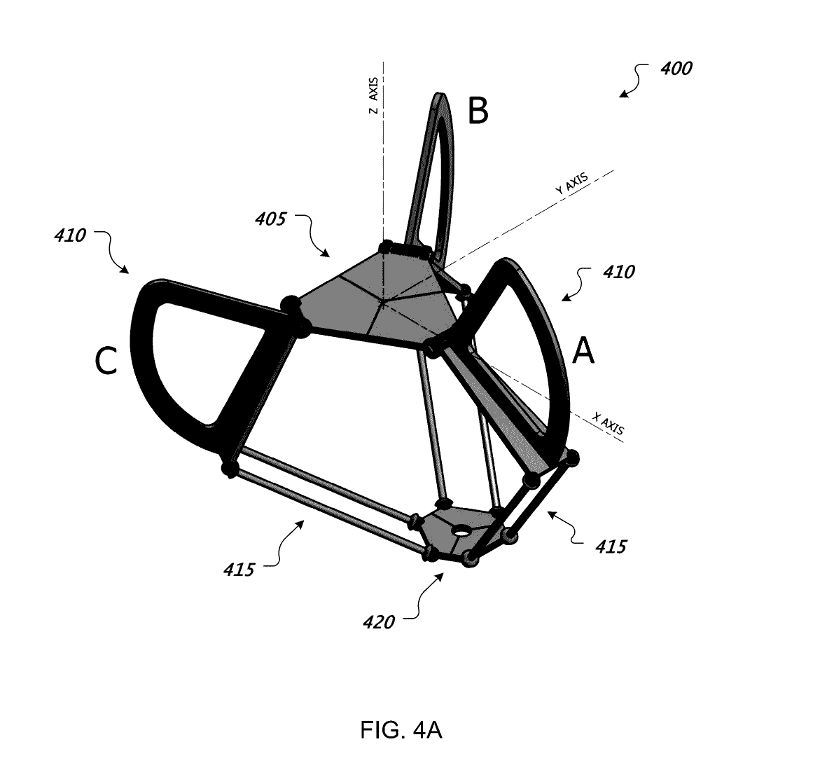

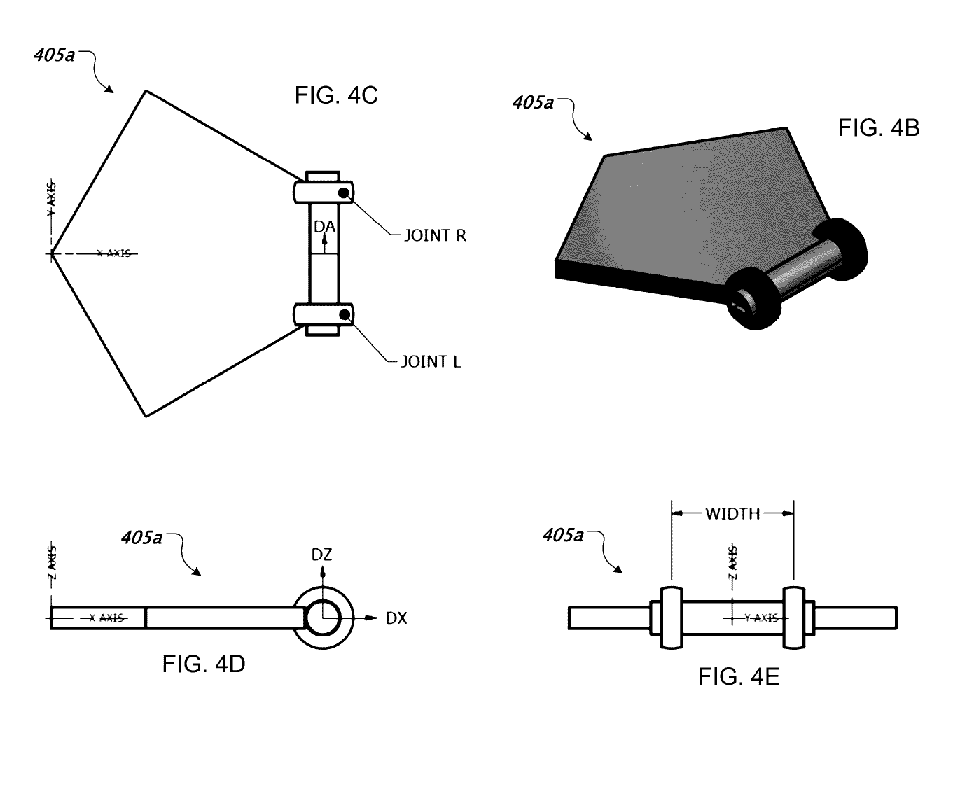

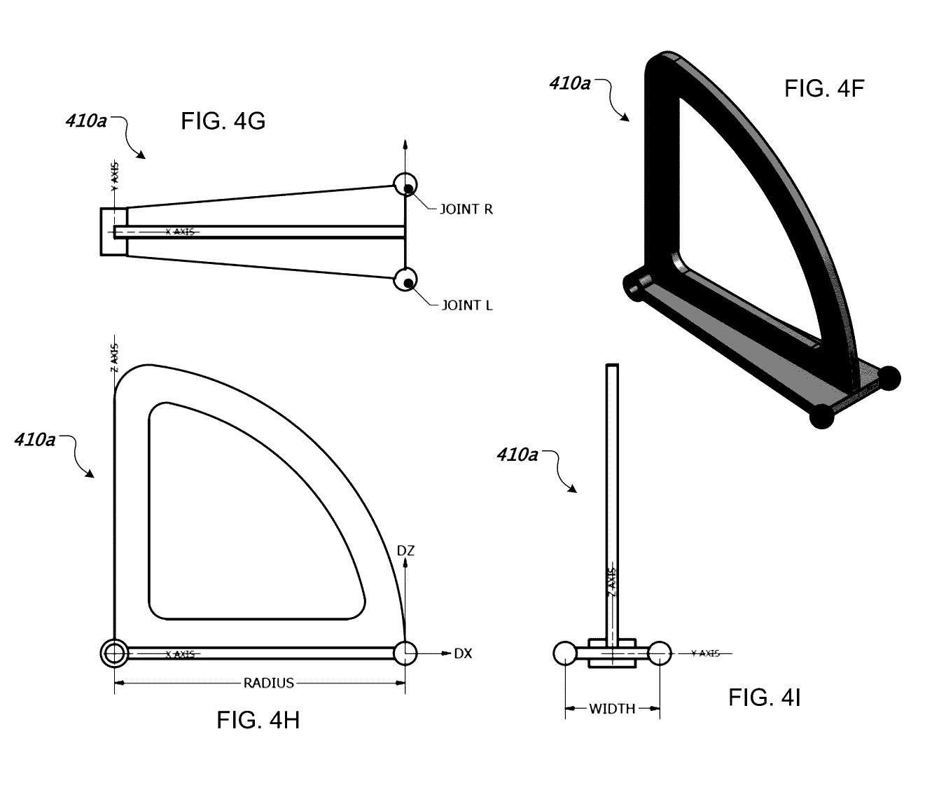

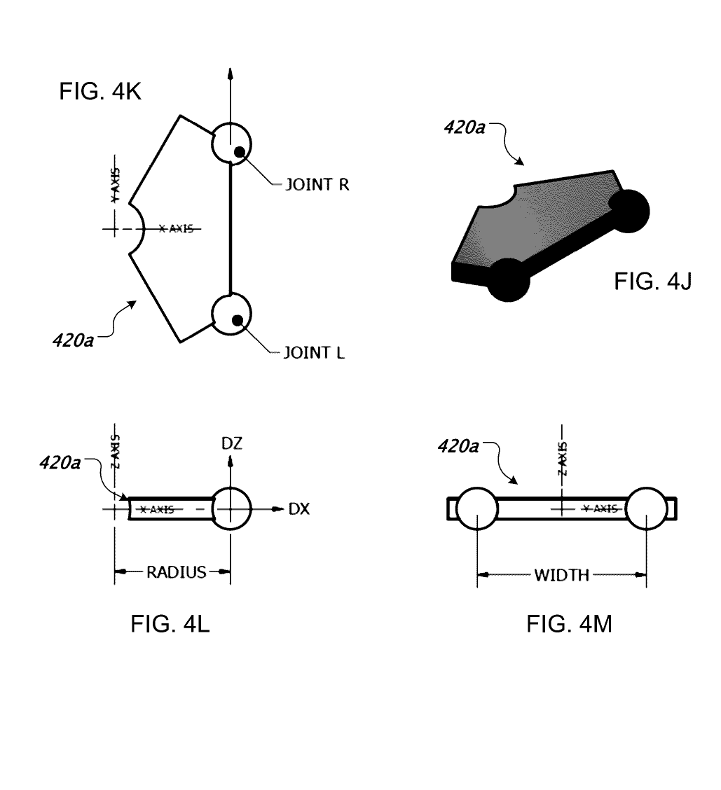

Regardless of such modifications in the mechanical structures, 3D printer delta motion systems in accordance with the present disclosure include hardware, firmware and/or software that moves the sector shaped bodies to cause the printer carriage to move as desired in 3D space within the build volume. FIG. 4A shows an example of a circular perimeter drive assembly 400, which includes a triangular portion 405 of the 3D printer frame and sector shaped bodies 410 that move a carriage 420 using rigid bodies (e.g., arms) 415. For purposes of describing the 3D motion of the carriage, the circular perimeter drive assembly 400 is shown divided into three sections A, B & C, in relation to X, Y & Z axes.

FIG. 4B shows a perspective view of a portion 405a of the 3D printer frame for the A section of the circular perimeter drive assembly 400. FIG. 4C shows a top view of the frame portion 405a, with the X axis and Y axis lying in the plane of the page and the axis of rotation DA for the A section shown in relation to joints R & L for the rotatable connection with the sector shaped body. FIG. 4D shows a side view of the frame portion 405a, with the X axis and Z axis lying in the plane of the page and X and Z references DX & DZ shown in relation to the axis of rotation. FIG. 4E shows a front view of the frame portion 405a, with the Z axis and Y axis lying in the plane of the page and the width between joints R & L shown.

FIG. 4F shows a perspective view of a sector shaped body 410a of the 3D printer frame for the A section of the circular perimeter drive assembly 400. FIG. 4G shows a top view of the sector shaped body 410a, with the X axis and Y axis lying in the plane of the page and additional joints R & L shown where universal joint connections between the sector shaped body 410a and arms 415 can be made. FIG. 4H shows a side view of the sector shaped body 410a, with the X axis and Z axis lying in the plane of the page, X and Z references DX & DZ shown in relation to the connection points for the arms 415, and the radius (i.e., of the circle defined by the outer arc of the sector shaped body 410a) noted between the axis of rotation and the connection points for the arms 415. FIG. 4I shows a front view of the sector shaped body 410a, with the Z axis and Y axis lying in the plane of the page and the width between joints R & L from FIG. 4G shown.

FIG. 4J shows a perspective view of a portion 420a of the carriage 420 from FIG. 4A. FIG. 4K shows a top view of the carriage portion 420a, with the X axis and Y axis lying in the plane of the page and further joints R & L shown where universal joint connections between the carriage portion 420a and the arms 415 can be made. FIG. 4L shows a side view of the carriage portion 420a, with the X axis and Z axis lying in the plane of the page, X and Z references DX & DZ shown in relation to the connection points for the arms 415, and the radius (i.e., of the circle defined by the dimensions of the carriage 420) noted between the connection points for the arms 415 and the center of the carriage 420. FIG. 4M shows a front view of the carriage portion 420a, with the Z axis and Y axis lying in the plane of the page and the width between joints R & L from FIG. 4K shown.

With the coordinate system shown in FIGS. 4A-4M in mind, a vector solution for 3D delta printer kinematics, with a model for nominal dimensions, is now described. Inverse kinematics of a 3D printer delta motion system can implemented in accordance with the following equations:

E₀=[x₀, y₀, z₀]

E₀′=[x₀, 0, z₀]

E₁′=[x₀+rₑ, 0, z₀]

rᵣ′=\sqrt{rᵣ²−x₀²}

Two circles are defined by:

(x−x₁)²+(z−z₁)²=rᵣ′²

(x−x₃)²+(z−z₃)²=r_{b}²

A shift is made so the origin is at the shoulder pivot point of the frame:

(x−x₀′)²+(z−z₀)²=rᵣ′²

x₀′=x₀+rₑ−r_{f}

x²+z²=rₛ²

And a generic formula for points of intersection between two circles is as follows:

$$d = \sqrt{{( {a}_{m} - {a}_{n} )}^{2} + {( {b}_{m} - {b}_{n} )}^{2}}$$

$$l = \frac{{r}_{m}^{2} + {r}_{n}^{2} + {d}^{2}}{2 d}$$

$$h = \sqrt{{r}_{m}^{2} - {l}^{2}}$$

$$a = \frac{l}{d} ( {a}_{n} - {a}_{m} ) \pm \frac{h}{d} ( {b}_{n} - {b}_{m} ) + {a}_{m}$$

$$b = \frac{l}{d} ( {b}_{n} - {b}_{m} ) ∓ \frac{h}{d} ( {a}_{n} - {a}_{m} ) + {b}_{m}$$

Plugging in the circles, aₘ=0, bₘ=0, rₘ=rₛ, aₙ=x₀′, bₙ=z₀, and rₙ=rᵣ′, results in:

$$d = \sqrt{{x}_{0}^{′2} + {z}_{0}^{2}}$$

$$l = \frac{{r}_{s}^{2} - {r}_{r}^{′2} + {d}^{2}}{2 d}$$

$$h = \sqrt{{r}_{s}^{2} - {l}^{2}}$$

$$x = \frac{l}{d} {x}_{0}^{′} \pm \frac{h}{d} {z}_{0}$$

$$z = \frac{l}{d} {z}_{0} ∓ \frac{h}{d} {x}_{0}^{′}$$

Forward kinematics of a 3D printer delta motion system can implemented in accordance with the following equations, beginning with the equations for three circles:

(x−x₁)²+(y−y₁)²+(z−z₁)²=rₑ² (1)

(x−x₂)²+(y−y₂)²+(z−z₂)²=rₑ² (2)

(x−x₃)²+(y−y₁)²+(z−z₃)²=rₑ² (3)

Multiplying out (noting that y₁=0) results in:

x²+y²+z²−2x₁x−2z₁z=rₑ²−x₁²−z₁² (4)

x²+y²+z²−2x₂x−2y₂y−2z₂z=rₑ²−x₂²−y₂²−z₂² (5)

x²+y²+z²−2x₃x−2y₃y−2z₃z=rₑ²−x₃²−y₃²−z₃² (6)

Subtracting the equations from each other results in:

(x₂−x₁)x+y₂y+(z₂−z₁)z=(w₂−w₁)/2 (7)

(x₃−x₁)x+y₃y+(z₃−z₁)z=(w₃−w₁)/2 (8)

(x₂−x₃)x+(y₂−y₃)y+(z₂−z₃)z=(w₂−w₃)/2 (9)

where:

w₁=x₁²+y₁²+z₁² (10)

w₂=x₂²+y₂²+z₂² (11)

w₃=x₃²+y₃²+z₃² (12)

Subtracting and rearranging to solve for y gives:

$$y = \frac{( {w}_{2} - {w}_{1} / 2 - ( {x}_{2} - {x}_{1} ) x - ( {z}_{2} - {z}_{1} ) z}{{y}_{2}} \qquad ( 13 )$$

Substituting and solving for x in terms of z gives:

$$\begin{matrix}( {x}_{2} - {x}_{3} ) {y}_{2} x + ( {y}_{2} - {y}_{3} ) ( ( {w}_{2} - {w}_{1} ) / 2 - ( {x}_{2} - {x}_{1} ) x - ( {z}_{2} - {z}_{1} ) z ) + ( {z}_{2} - {z}_{3} ) {y}_{2} z = ( {w}_{2} - {w}_{3} ) {y}_{2} / 2 & ( 14 ) \\ ( ( {x}_{2} - {x}_{3} ) {y}_{2} - ( {x}_{2} - {x}_{1} ) ( {y}_{2} - {y}_{3} ) ) x = ( ( {y}_{2} - {y}_{3} ) ( {z}_{2} - {z}_{1} ) + {y}_{2} ( {z}_{2} - {z}_{3} ) ) z + ( {w}_{2} - {w}_{3} ) {y}_{2} / 2 - ( {w}_{2} - {w}_{1} ) ( {y}_{2} - {y}_{3} ) / 2 & ( 15 ) \\ x = {a}_{1} z + {b}_{1} & ( 16 ) \\ {d}_{1} = ( {x}_{2} - {x}_{3} ) {y}_{2} - ( {x}_{2} - {x}_{1} ) ( {y}_{2} - {y}_{3} ) ) & ( 17 ) \\ {a}_{1} = \frac{1}{d} ( ( {y}_{2} - {y}_{3} ) ( {z}_{2} - {z}_{1} ) = {y}_{2} ( {z}_{2} - {z}_{3} ) ) & ( 18 ) \\ {b}_{1} = \frac{1}{2 d} ( ( {w}_{2} - {w}_{3} ) {y}_{2} - ( {w}_{2} - {w}_{1} ) ( {y}_{2} - {y}_{3} ) ) & ( 19 )\end{matrix}$$

Substituting and solving for y in terms of z gives:

$$\begin{matrix}x = \frac{( {w}_{3} - {w}_{1} ) / 2 - {y}_{3} y - ( {z}_{3} - {z}_{1} ) z}{( {x}_{3} - {x}_{1} )} & ( 20 ) \\ ( ( {x}_{3} - {x}_{1} ) ( {y}_{2} - {y}_{3} ) - ( {x}_{2} - {x}_{3} ) {y}_{3} ) y = ( ( {x}_{2} - {x}_{3} ) ( {z}_{3} - {z}_{1} ) - ( {x}_{3} - {x}_{1} ) ( {z}_{2} - {z}_{3} ) ) z + ( {x}_{3} - {x}_{1} ) ( {w}_{2} - {w}_{3} ) / 2 - ( {x}_{2} - {x}_{3} ) ( {w}_{3} - {w}_{1} ) / 2 & ( 21 ) \\ y = {a}_{2} z + {b}_{2} & ( 22 ) \\ {d}_{2} = ( {x}_{3} - {x}_{1} ) ( {y}_{2} - {y}_{3} ) - ( {x}_{2} - {x}_{3} ) {y}_{3} & ( 23 ) \\ {a}_{2} = \frac{1}{d} ( ( {x}_{2} - {x}_{3} ) ( {z}_{3} - {z}_{1} ) - ( {x}_{3} - {x}_{1} ) ( {z}_{2} - {z}_{3} ) ) & ( 24 ) \\ {b}_{2} = \frac{1}{2 d} ( ( {x}_{3} - {x}_{1} ) ( {w}_{2} - {w}_{3} ) - ( {x}_{2} - {x}_{3} ) ( {w}_{3} - {w}_{1} ) ) & ( 25 )\end{matrix}$$

Substituting back into the original equation for the circle results in:

(a₁z+(b₁−x₁))²+(a₂z+(b₂−y₁))²+(z−z₁)²=r₂²

a₁²z²+2a₁(b₁−x₁)z+(b₁−x₁)²+a₂²z²+2a₂(b₂−y₁)z+(b₂−y₁)²+z²−2z₁z+z₁²=rₑ² (26)

(a₁²+a₂²+1)z²+2(a₁(b₁−x₁)+a₂(b₂−y₁)−z₁)z+((b₁−x₁)²+(b₂−y₁)²+z₁²−rₑ²)=0 (27)

Finally, solving for z can be done with the quadratic equation:

$$\begin{matrix}{Az}^{2} + Bz + C = 0 & ( 28 ) \\ A = {a}_{1}^{2} + {a}_{2}^{2} + 1 & ( 29 ) \\ B = 2 ( {a}_{1} ( {b}_{1} - {x}_{1} ) + {a}_{2} ( {b}_{2} - {y}_{1} ) - {z}_{1} ) & ( 30 ) \\ C = ( {( {b}_{1} - {x}_{1} )}^{2} + {( {b}_{2} - {y}_{1} )}^{2} + {z}_{1}^{2} - {r}_{e}^{2} ) & ( 31 ) \\ z = \frac{- B \pm \sqrt{{B}^{2} - 4 A C}}{- 2 A} & ( 32 )\end{matrix}$$

Note that solving for x and y is trivial with known z using equations 16 and 22.

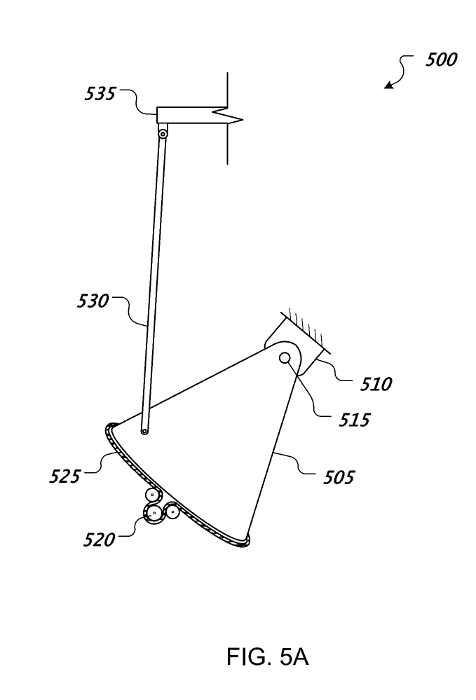

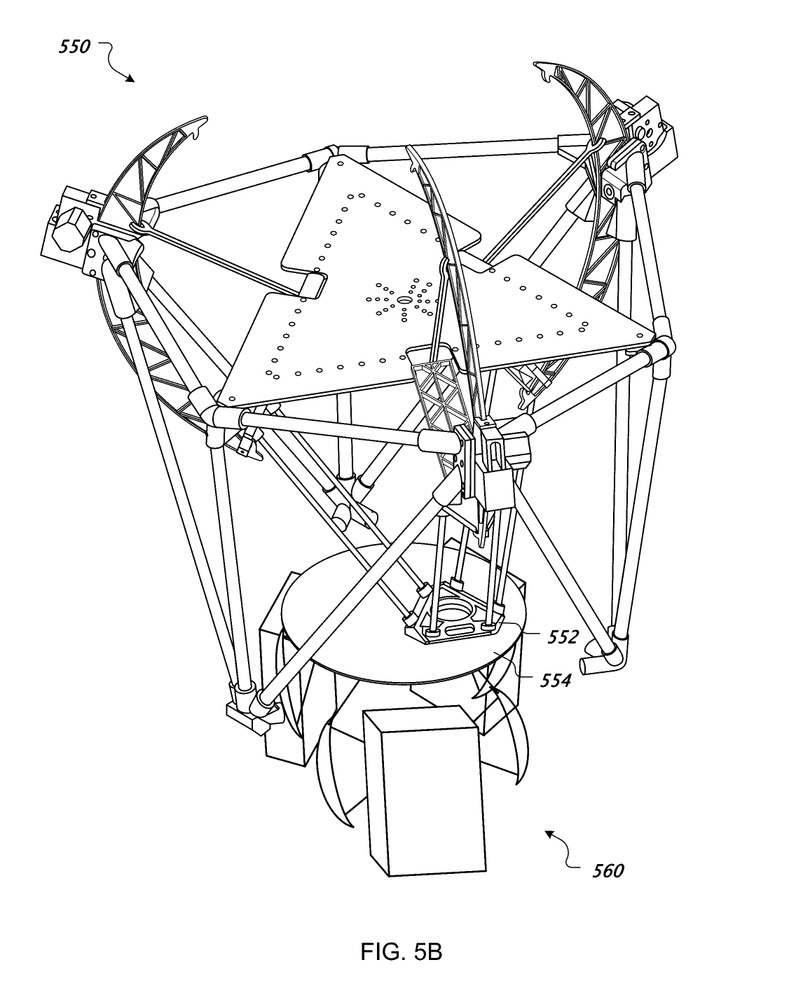

In addition, although this disclosure focuses on 3D printing and the use of a circular perimeter drive assembly for delta-style, 3-axis movement, the circular perimeter drive systems and techniques described can also be used for Stewart platform, 6-axis movement (also referred to as hexapod machine movement), either in the context of a 3D printer or in other applications, e.g., subtractive machining operations, pick-and-place robotic applications, etc. FIGS. 5A & 5B show examples of using a circular perimeter drive assembly with a Stewart platform.

In FIG. 5A, a circular perimeter drive assembly 500 includes a sector shaped body 505 that attaches to a base or frame 510 at a pivot 515. The sector shaped body 505 can be moved about the pivot 515 using a drive gear 520 and a band 525, similar to those described above. Moreover, as before, other structures can be used, including one or more gears with teeth, one or more wheels, one or more idlers, a belt or chain, direct engagement by the motor, or indirect engagement by the motor. Six such structures can be used with six respective rigid bodies (e.g., arms) 530 to provide six degrees of freedom of movement to a platform 535. Further, such a platform can be used in a 3D printer in connection with a carriage for the 3D printer (e.g., to move a hot end within a build volume), with a build platform for the 3D printer, or both.

FIG. 5B shows an example of a delta 3D printer 550 in which circular perimeter drive structures are used to move both a carriage 552 and a build platform 554. For the carriage 552, the circular perimeter drive structures are the same as those described above. For the build platform 554, the use of the circular perimeter drive structures (shown here without the motors for the sector shaped bodies) creates a Stewart platform 560 on which an object can be created using additive manufacturing systems and techniques. Thus, the carriage 552 has three degrees of freedom while the build platform 554 has six degrees of freedom. In some implementations, the carriage 552 is also implemented as a Stewart platform. As before, various types of motors and engagement structures can be used for the Stewart platform(s). In addition, various types of frames or bases can be used to hold the motors and the supports for the pivots of the circular perimeter drive structures.

While this specification contains many implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Thus, particular embodiments of the invention have been described. Other embodiments are within the scope of the following claims. In addition, the actions recited in the claims can be performed in a different order and still achieve desirable results.

What is claimed is:

1. A three dimensional (3D) delta printer comprising:
a build platform;
a 3D printer delta motion system; and
a space frame configured and arranged to support the 3D printer delta motion system as the 3D printer delta motion system moves relative to the build platform;
wherein the space frame comprises multiple triangular units surrounding a build volume above the build platform.

2. The 3D delta printer of claim 1, wherein the 3D printer delta motion system comprises three drive units located in three respective sections of the space frame, and each of the three respective sections of the space frame comprises three triangular facets forming angles with respect to the build platform that are greater than ninety degrees.

3. The 3D delta printer of claim 1, wherein the multiple triangular units of the space frame form eight triangular facets.

4. The 3D delta printer of claim 1, wherein the multiple triangular units of the space frame form fourteen triangular facets.

5. The 3D delta printer of claim 4, wherein a top center facet of the fourteen triangular facets is parallel with a plate on a top center position of the space frame over the build volume.

6. The 3D delta printer of claim 1, wherein the multiple triangular units comprise beams connected at nodes.

7. The 3D delta printer of claim 6, comprising a triangular plate on a top center position of the space frame over the build volume.

8. The 3D delta printer of claim 7, wherein the triangular plate has truncated corners.

9. The 3D delta printer of claim 7, wherein the triangular plate includes perforations.

10. The 3D delta printer of claim 6, wherein the beams comprise tubes.

11. The 3D delta printer of claim 6, wherein the nodes comprise welded junctions for the beams.

12. The 3D delta printer of claim 6, wherein the nodes comprise fastened junctions for the beams.

13. The 3D delta printer of claim 6, wherein the nodes comprise 3D printed junctions for the beams.

14. The 3D delta printer of claim 1, wherein the multiple triangular units comprise metal bent to specific angles.
